(19) United States
(12) Patent Application Publication
(10) Pub. No.: US 2010/0269131 A1
(43) Pub. Date: Oct. 21, 2010

(54) Method and System for Trick Mode Suppression Control

(75) Inventors: Thomas Patrick Newberry, Westfield, IN (US); David John Weaver, Fishers, IN (US); Mark Allen McCleary, Indianapolis, IN (US)

Correspondence Address: Robert D. Shedd, Patent Operations;THOMSON Licensing LLC, P.O. Box 5312, Princeton, NJ, 08543-5312, US

(73) Assignee: THOMSON LICENSING, Boulogne-Billancourt (FR)

(21) Appl. No.: 12/308,592

(22) PCT Filed: Nov. 20, 2006
(86) PCT No.: PCT/US2006/044962

§ 371 Date: Dec. 18, 2008

Related U.S. Application Data
(60) Provisional application No. 60/818,890, filed on Jul. 6, 2006.

(51) Int. Cl. H04N 5/93; H04N 7/025

(52) U.S. Cl. 725/32; 386/52; 386/E05.003

(57) ABSTRACT

The present application provides a method and system for the control of trick mode suppression schemes in media content such that trick mode support can be re-enabled for the received content. In one embodiment of the present invention, a method for trick mode suppression control includes examining a received media content signal to identify trick mode disabled portion (s) of the media content. The method further includes monitoring identified trick mode disabled portions of the media content to determine which portion (s) of a trick mode disabled portion of the media content have been viewed. In one embodiment, trick mode functionality is then restored for the portions of the trick mode disabled media content that satisfy the preview conditions defined in the media content as it is being viewed.

### FIELD OF THE INVENTION

The present invention generally relates to content having trick mode suppression and, more particularly, to a method and system for the control of trick mode suppression schemes in media content such that trick mode support can be re-enabled for the content.

### BACKGROUND OF THE INVENTION

Television commercial messages (commercials) have become a common way to advertise products, manufacturers, services, politicians, charities, etc. on behalf of their sponsors. Television commercials can be informative, educational or entertaining, and can, in some instances, be worthy of retaining for future viewing. For example, certain television commercials can contain historically significant political messages, while others can be entertaining as shown during the annual Super Bowl. Some commercials, however, can be bothersome and/or uninteresting.

With the advent of disc drive based content recorders (i.e., personal video recorders (PVRs)) and to some extent video tape recorders (VTRs), a user is able to control viewing of television programming by time shifting the programming and using trick play modes such as “fast forward” to skip portions of the recorded programming such as, for example, the commercials. Commercial skipping can become a serious problem for broadcasters because broadcasters are compensated by sponsors who pay for commercials to be presented to the viewing audience. If a broadcaster cannot guarantee a sponsor that a commercial will be shown, a sponsor can become reluctant to pay for that advertising space and time.

In an effort to assure advertisers that commercials will be shown, even during a time shifting scenario, broadcasters have developed media content having playback requirements communicated with the content to be followed during playback of the content. For example, media content today can contain start/end synchronization packets or special commercial data packets that can contain a byte of data that indicates playback requirements established or set by a broadcaster for any given programming to be recorded, such as a commercial.

To minimize consumer annoyance, a broadcaster can minimize a number of forced playbacks of recorded programming. For example a broadcaster can sell forced playback commercial slots at a premium, but minimize the number of such forced slots in a television program. The forced playback slots are locations in the media content in which trick modes are disabled.

In one example of configured playback rights, the playback rights for a commercial are stored along with the recorded television program. In such examples, counters are configured to determine a number of times that a commercial has been fully viewed. Once the number of times a commercial is viewed satisfies a predetermined threshold, trick modes (e.g., fast forward, skip ahead) can again be enabled. In such currently available systems, a commercial is considered as having been viewed when all frames for the commercial have been rendered to the user during playback. As such in such prior art systems, trick modes cannot be enabled until a commercial is viewed in its entirety for a predetermined number of times.

### SUMMARY OF THE INVENTION

The present invention advantageously provides a method and system for the control of trick mode suppression schemes in media content such that trick mode support can be re-enabled for the received content.

In one embodiment of the present invention a method for trick mode suppression control includes examining a received media content signal to identify trick mode disabled portion(s) of the media content. The method further includes monitoring identified trick mode disabled portions of the media content to determine which portion(s) of a trick mode disabled portion of the media content have been viewed. Trick mode functionality is then restored for the portions of the trick mode disabled media content that satisfy the preview conditions defined in the media content received from the source as it is being viewed.

In an alternate embodiment of the present invention, a system for trick mode suppression control for media content including preview conditions for portions of the media content includes a recording/play device including a memory and a processor configure to perform the steps of examining the received media content signal to identify trick mode disabled portion(s) of the media content, monitoring identified trick mode disabled portions of the media content to determine which portion(s) of a trick mode disabled portion of the media content have been viewed, and restoring trick mode functionality for the portions of the trick mode disabled media content that satisfy the preview conditions defined in the media content.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a personal video recorder for implementing the inventive concepts in accordance with one embodiment of the present invention;

FIG. 2 depicts a real-time timeline of trick mode disabled media content during a viewing mode;

FIG. 3 depicts a flow diagram of a method for controlling trick mode suppression in accordance with one embodiment of the present invention; and

FIG. 4 depicts a high level block diagram of a of a user interface in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method and system for the control of trick mode suppression schemes in media content such that trick mode support can be re-enabled for the received content. Although the present invention will be described primarily within the context of a specific recording device comprising specific components, the specific embodiments of the present invention should not be treated as limiting the scope of the invention. It will be appreciated by those skilled in the art and informed by the teachings of the present invention that the concepts of the present invention can be advantageously applied in substantially any recording or playback device receiving media content with trick mode suppression schemes for the control of trick mode suppression schemes in the media content such that trick mode support can be re-enabled for the received content. For example, while a Personal Video Recorder (PVR) is used as an example throughout the teachings of the present invention, any digital television receiving device with similar functionality, such as a Digital Video Recorder, Set-top Box or television receiver, and the like is considered to be the same or equivalent.

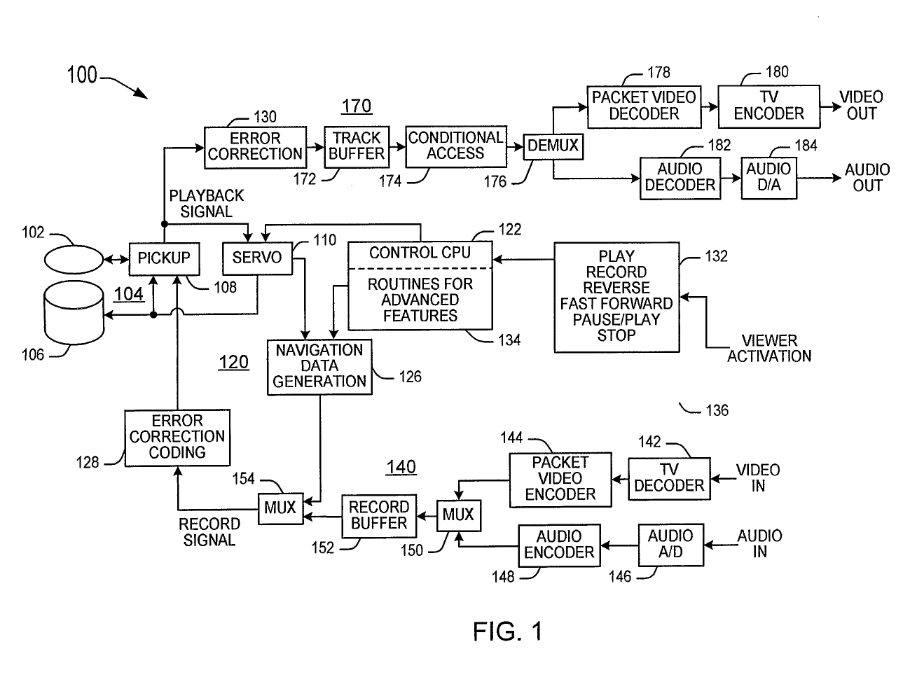

FIG. 1 depicts a high level block diagram of a recording device for implementing the advanced operating features in accordance with one embodiment of the present invention. The recording device 100 of FIG. 1 illustratively comprises a mechanical assembly 104, a control section 120, a video/audio input processing path 140 and a video/audio output processing path 170. The allocation of most of the blocks to different sections or paths is self-evident, whereas the allocation of some of the blocks is made for purposes of convenience and is not critical to understanding the operation of the recording device.

The mechanical assembly 104 comprises a motor 106 for spinning a storage disc 102 and a pickup assembly 108 that is adapted to be moved over the spinning disc 102. A laser on the pickup assembly 108 burns spots onto a spiral track on the disc 102 or illuminates spots already burned onto the track for recording and playing back video and/or audio program material. For purposes of understanding the invention, it is irrelevant whether the disc 102 is recordable on one or two sides, or in the event of a double-sided recording, whether the double-sided recording, or subsequent reading from the disc 102, takes place from the same side of the disc or from both sides. The pickup assembly 108 and the motor 106 are controlled by a servo 110. The servo 110 also receives the Playback Signal of data read from the spiral track of the disc 102 as a first input. The Playback Signal is also an input to an error correction circuit 130, which can be considered part of the control section or part of the video/audio output processing path 170.

The control section 120 comprises a control central processing unit (CPU) 122 and a navigation data generation circuit 126. The control CPU 122 supplies a first input signal to the navigation data generation circuit 126, and the servo 110 supplies a second input signal to the navigation data generation circuit 126. The servo 110 can also be considered part of the control section 120. The navigation data generation circuit 126 supplies first input signal to the multiplexer (MUX) 154, which forms part of the video/audio input processing path 140.

The output of the MUX 154 is an input to an error correction coding circuit 128. The output of the error correction coding circuit 128 is a recordable input signal supplied to the pickup 108, which will be “burned” onto the spiral track of the disc 102 by the laser.

The control CPU 122 also preferably has access to the data contained in the track buffer 172 and record buffer 152 as shown in FIG. 1. The control CPU 122 can delete, modify, and reformat video data stored in the track buffer 172 and record buffer 152. Control and data interfaces are also preferably provided for permitting CPU 122 to control the operation of video encoder 144 and audio encoder 148. Suitable software or firmware is provided in memory for the conventional operations performed by control CPU 122.

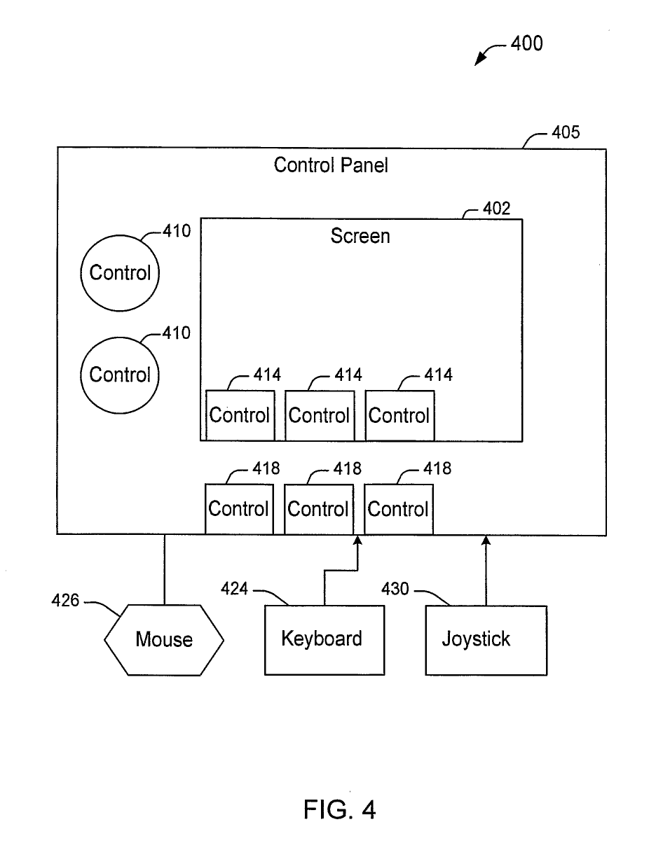

A control buffer 132 is provided for viewer activatable functions such as play, record, rewind, fast forward, slow play, jump, pause/play, stop and the like. The control buffer 132 can comprise a user interface provided for communicating viewer inputs. For example, FIG. 4 depicts a high level block diagram of user interface in accordance with an embodiment of the present invention. The user interface 400 of FIG. 4 can include a control panel 405 having a screen or display 402 or can be implemented in software as a graphical user interface. Controls 410-426 can include actual knobs/sticks 410, keypads/keyboards 424, buttons 418-422 virtual knobs/sticks and/or buttons 414, a mouse 426, a joystick 430 and the like, depending on the implementation of the user interface 400.

The video/audio input processing path 140 is a signal processing circuit for converting a conventional television signal, for example NTSC or PAL, into digitized packet data, for example MPEG-1 or MPEG-2, for digital recording by the device 100. The input path 140 comprises an NTSC decoder 142 and video encoder, for example MPEG-1 or MPEG-2, 144 for video in, and comprises an audio analog-to-digital converter (A/D) 146 and an audio encoder, for example MPEG, AC3 or DTS, 148. The digitized signals are combined in a multiplexer 150 and stored in the record buffer 152 until an entire packet has been constructed. As groups of audio and video data packets are created, they are combined in MUX 154 with appropriate navigation packets generated in the navigation generation block 126. The packets are then sent to the error correction coding circuit 128. Error correction coding circuit 128 can also be deemed to be part of the input path 140.

The output processing path 170 comprises error correction block 130 and a track buffer, or output buffer, 172, in which data read from the disc 102 is temporarily stored for further processing. This data is processed by conditional access circuit 174 that controls propagation of the data through demultiplexer 176 and into respective paths for video and audio processing.

The video is decoded by decoder 178, for example from MPEG-1 or MPEG-2, and encoded as a conventional television signal, for example NTSC or PAL. The audio is decoded by circuit 182, for example from MPEG, AC3 or DTS, and converted to analog form by audio digital-to-analog (D/A) converter 184.

Notably, the present invention can be realized in hardware, software, or a combination of hardware and software. Machine readable storage according to the present invention can be realized in a centralized fashion in one computer system, for example the control CPU 122, or in a distributed fashion where different elements are spread across several interconnected computer systems. Any kind of computer system or other apparatus adapted for carrying out the methods described herein is acceptable.

Specifically, although the present invention as described herein specifically comprises a control CPU 122 of FIG. 1, a typical combination of hardware and software could be a general purpose computer system with a computer program that, when being loaded and executed, controls the computer system and a recording system similar to the control section 120 of FIG. 1 such that it carries out the methods described herein. The present invention can also be embedded in a computer program product which comprises all the features enabling the implementation of the methods described herein, and which when loaded in a computer system is able to carry out these methods.

A computer program in the present context can mean any expression, in any language, code or notation, of a set of instructions intended to cause a system having an information processing capability to perform a particular function either directly or after either or both of the following: (a) conversion to another language, code or notation; and (b) reproduction in a different material form. The invention disclosed herein can be a method embedded in a computer program which can be implemented by a programmer using commercially available development tools for operating systems compatible with the control CPU 122 described above.

Trick Mode Suppression Control

As previously mentioned, broadcasters have developed media content including trick mode suppression schemes. More specifically, content has been developed that requires that at least specific portions of the content (e.g., commercials) be viewed at least one before allowing the fast-forwarding or rewinding of at least those specific portion of the content. In accordance with various embodiments of the present invention, such trick mode disabled media content can be monitored in real time for determining which portions of the, trick mode disabled content has already been viewed and enabling trick mode functionality for the portions of the trick mode disabled content that has been viewed.

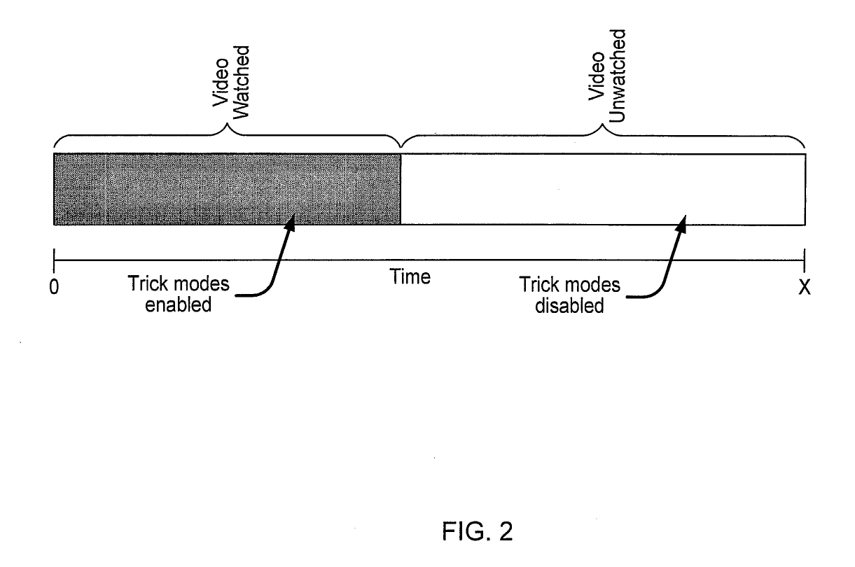

For example, FIG. 2 depicts a real-time timeline of trick mode disabled media content during a viewing mode. As depicted in FIG. 2, the trick mode disabled media content is monitored and as the trick mode disabled media content is viewed, the trick mode functionality is enabled in the portions of the media content that have been viewed. More specifically, in one embodiment of the present invention, the recording device 100 of FIG. 1 receives media content from a source such as a broadcaster. The recording device 100 examines the received media content to determine trick mode disabled portions of the received media content (i.e., portions of the media content having viewing requirements). When the recording device 100 identifies trick mode disabled media content, the recording device continues to monitor the received media content and identifies portions of the trick mode disabled media content that have been watched in real-time. As the media content is being watched, the recording device 100 enables trick mode functionality for the portions of the trick mode disable media content that satisfy the preview conditions defined in the media content received from the source.

For example, in one embodiment of the present invention, trick mode disabled media content received by the recording device 100 contains information indicating that portions of the broadcast media content must be watched at least once. As such and as described above, the recording device 100 examines the received media content to determine trick mode disabled portions of the received media content. When the recording device 100 identifies trick mode disabled media content, the recording device monitors the received media content and identifies portions of the trick mode disabled media content that have been watched at least once. As the media content is being watched, the recording device 100 enables trick mode functionality for the portions of the trick mode disable media content that satisfy the preview conditions defined in the media content received from the source, in this case the portions of the trick mode disabled media content that have been viewed at least once.

In an alternate embodiment of the present invention, trick mode disabled media content received by the recording device 100 contains information indicating that portions of the broadcast media content must be watched more than once, for example twice. As such and as described above, the recording device 100 examines the received media content to determine trick mode disabled portions of the received media content. When the recording device 100 identifies trick mode disabled media content, the recording device monitors the received media content and identifies portions of the trick mode disabled media content that have been watched. The recording device 100 keeps track of which portions of the trick mode disabled media content have been watched. For example, in one embodiment of the present invention, a data file is created and stored in a memory of the recording device 100 identifying which trick mode disabled portions of the media content have been watched and how many times each of the portions have been respectively watched. As the media content is being watched, the recording device 100 enables trick mode functionality for the portions of the trick mode disable media content that satisfy the preview conditions defined in the media content received from the source, in this case the portions of the trick mode disabled media content that have been viewed at least twice.

Although in the embodiments described above it is taught that preview conditions for the trick mode disabled portions of the media content are received with the media content, in alternate embodiments of the present invention, preview conditions for the trick mode disabled portions of the media content can be input, for example, via the user interface 400 or received via a separate transmission to the recording device of the present invention from for example, the content source, subscription service, or substantially any other means of providing preview conditions for the trick mode disabled portions of the media content.

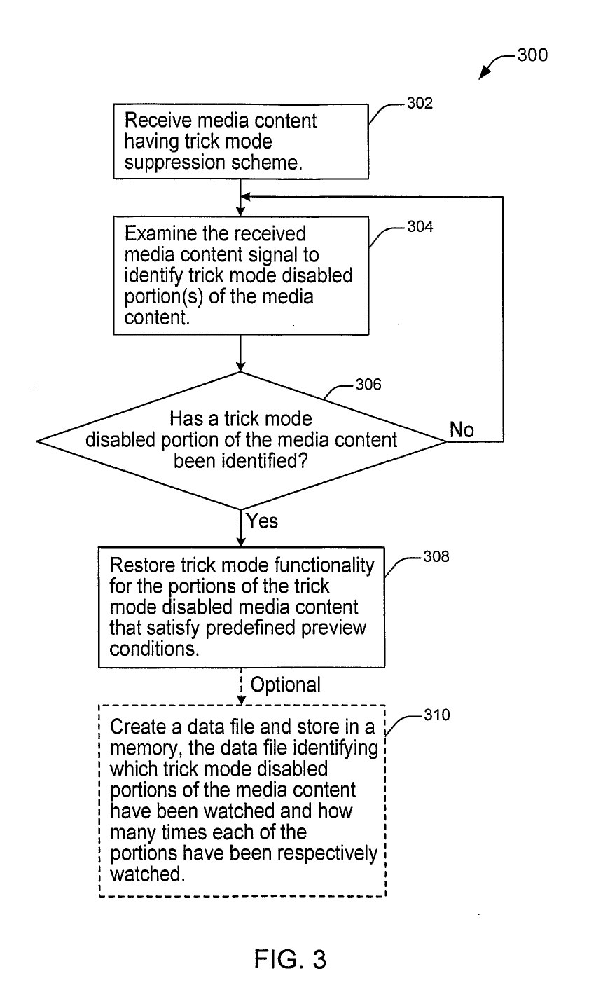

FIG. 3 depicts a flow diagram of a method for controlling trick mode suppression in accordance with one embodiment of the present invention. The method 300 of FIG. 3 begins in step 302 in which a media content signal having a trick mode suppression scheme is received. That is, a media content signal having at least one identified trick mode disabled portion is received by a recording/play device in accordance with the present invention. The method 300 then proceeds to step 304.

At step 304, the received media content signal is examined to detect the presence of at least one trick mode disabled portion of the media content signal. If a trick mode disable portion is detected the method proceeds to step 306. If a trick mode disabled portion is not detected, the received media content signal continues to be examined.

At step 306, a trick mode disabled portion of the received media content is monitored to determine which portions of the trick mode disabled media content have been viewed. The method 300 then proceeds to step 308.

At step 308, trick mode functionality is restored for the portions of the trick mode disabled media content that satisfy predefined preview conditions. For example and as described above, in one embodiment of the present invention, the preview conditions can be defined in the media content received from the source as it is being viewed. That is, in one embodiment of the present invention, the received media content contains a preview condition for the trick mode disabled portion(s) of the content such that the trick mode disabled portion(s) of the media content must be viewed at least once. In such an embodiment, as the media content is being watched, the recording device of the present invention enables trick mode functionality for the portions of the trick mode disable media content that satisfy the preview conditions defined in the media content received from the source, in this case the portions of the trick mode disabled media content that have been viewed at least once. In alternate embodiments of the present invention, preview conditions for the trick mode disabled portions of the media content can be defined by a user input or via a separate transmission to the recording device of the present invention. The method 300 can then exit or can optionally proceed to step 310.

At step 310, a recording device of the present invention keeps track of which portions of the trick mode disabled media content have been watched. For example, in one embodiment of the present invention, a data file is created and stored in a memory of the recording device identifying which trick mode disabled portions of the media content have been watched and how many times each of the portions have been respectively watched. As the media content is being watched, the recording device 100 enables trick mode functionality for the portions of the trick mode disable media content that satisfy the preview conditions defined in the media content received.

Having described various embodiments for a method and system for the control of trick mode suppression schemes in media content (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. While the forgoing is directed to various embodiments of the present invention, other and further embodiments of the invention may be devised without departing from the basic scope thereof.

1. A method for controlling trick mode suppression in media content, comprising:
examining said media content signal to identify the presence of at least one trick mode disabled portion;
monitoring said at least one trick mode disabled portion of said media content to determine which portions have been viewed; and
restoring trick mode functionality for the portions of the trick mode disabled media content that satisfy preview conditions.

2. The method of claim 1, wherein said trick mode functionality is restored in real-time as the content satisfies the preview conditions.

3. The method of claim 1, wherein said preview conditions are received along with said media content.

4. The method of claim 1, wherein said preview conditions define a number of times that a trick mode disabled portion of said media content must be viewed before trick mode functionality can be restored.

5. The method of claim 1, further comprising storing information regarding which trick mode disabled portions of the media content have been viewed and how many times each of the portions have been respectively viewed.

6. The method of claim 1, wherein said trick mode disabled portions of said media content comprise commercials.

7. A method for disabling trick mode suppression in media content, comprising:
examining said media content signal to identify the presence of at least one trick mode disabled portion;
monitoring said at least one trick mode disabled portion of said media content to determine which portions have been viewed; and
restoring trick mode functionality for the portions of the trick mode disabled media content as the portions satisfy preview conditions.

8. The method of claim 7, wherein said preview conditions are received along with said media content.

9. The method of claim 7, wherein said preview conditions define a number of times that a trick mode disabled portion of said media content must be viewed before trick mode functionality can be restored.

10. The method of claim 7, further comprising storing information regarding which trick mode disabled portions of the media content have been viewed and how many times each of the portions have been respectively viewed.

11. The method of claim 7, wherein said trick mode disabled portions of said media content comprise advertising segments.

12. A system for controlling trick mode suppression in media content, comprising:
a user interface for enabling the selection of trick modes;
a storage means for storing at least one of said media content, programs and instructions, and information regarding said media content; and
a processor in communication with said storage means, said processor configured to:
examine said media content to identify the presence of at least one trick mode disabled portion;
monitor said at least one trick mode disabled portion of said media content to determine which portions have been viewed; and
restore trick mode functionality for the portions of the trick mode disabled media content that satisfy preview conditions.

13. The system of claim 12, wherein said user interface comprises at least one of a wireless remote control, a pointing device, such as a mouse or a trackball, a voice recognition system, a touch screen, on screen menus, buttons, and knobs.

14. The system of claim 12, wherein said system comprises an audio/video playback device for playing said media content.

15. The system of claim 12, wherein said system comprises a recording device.
